(19) United States
(12) Patent Application Publication
(10) Pub. No.: US 2010/0123290 A1
(43) Pub. Date: May 20, 2010

(54) Shaft seal arrangement of a chocolate fountain

(76) Inventors: Chun-Liang Wu, Taoyuan City (TW); Chun-Sen Wu, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,224

(22) Filed: Nov. 14, 2008

(51) Int. Cl. F16J 15/32

(52) U.S. Cl. 277/571

(57) ABSTRACT

A shaft seal arrangement of a chocolate fountain includes a transmission shaft coupled with a drive shaft having an n-shaped disc body. The bottom of the n-shaped disc body is provided with a supporting body. The material of the supporting body is selected from a group consisting of carbon, graphite, Teflon, and wearproof ceramics. The supporting body is pushed by a spring against the n-shaped disc body such that the top of the n-shaped disc body is constantly in sealed contact with a resilient spacer thereabove. In this way, the melted chocolate within the basin can be prevented from downward leakage, thereby ensuring a smooth operation of the transmission element as well as a prolonged service life.

### BACKGROUND OF THE INVENTION

1. Field of the Invention

The invention relates to a chocolate fountain, and more particularly, to an improvement of a shaft seal arrangement of a chocolate fountain.

2. Description of the Related Art

As shown in FIGS. 1 through 4, a few of chocolate machines 10 disclosed by C. Liang Wu include a base 11 on which a basin 12 is disposed. A motor 13 is installed therein. An auger 15 is driven by the motor 13 via a transmission shaft 14 in rotation within a cylinder 16. As a result, the melted chocolate within the basin 12 can be brought upward along the cylinder 16 at the center in a screwed way to the top 17 of the chocolate fountain. Thereafter, the melted chocolate flows from the top back to the basin 12. When the melted chocolate flows along the tiers, a chocolate waterfall effect is created.

No matter whether the motor 13 is laterally arranged (FIG. 2) or vertically arranged (FIG. 3), a shaft seal 19 has to be mounted at the connection between the transmission shaft 14 and the auger 15 for preventing the melted chocolate within the basin 12 from leakage. As shown in FIG. 4, the conventional shaft seal 19 includes a rubber sleeve 191 within a shaft hole at the bottom of the basin 12 through which the transmission shaft 14 passes. The rubber sleeve 191 is elastically and tightly mounted at the periphery of the transmission shaft 14 for preventing the melted chocolate (illustrated by dots) within the basin 12 from leakage.

After used for a long period, the shaft seal 19 of the shaft seal 19 creates a fatigue of elasticity such that the melted chocolate will leak into a bearing 192, thereby reducing the service life thereof. Moreover, the melted chocolate may leak into the base 11. Even, it may overflow from the housing and cause much trouble. Therefore, the conventional shaft seal requires further improvements.

### SUMMARY OF THE INVENTION

An object of the invention is to provide a shaft seal arrangement of a chocolate fountain that prevents the melted chocolate from leaking from the seal.

Another object of the invention is to provide a shaft seal arrangement of a chocolate fountain that possesses a pushing resilience constantly pushing the transmission element against a resilient spacer such that a long-term forcing effect to protect from leakage is ensured.

In order to achieve the above-mentioned object, a shaft seal arrangement of a chocolate fountain in accordance with the invention is interposed between the transmission shaft and the screw rod and includes a spring, a holding sleeve, an elastic sleeve, a supporting body, a drive shaft, a compression ring, and a resilient spacer:

The spring is received within an annular groove of the bearing seat. The annular groove is formed externally and concentrically to the bearing.

The holding sleeve is made of metallic material such as copper and U-shaped. A through hole is formed at the center of the holding sleeve such that the transmission shaft passes through the through hole without contact therewith. A flange is extended from the periphery of the holding sleeve and positioned on the top of the spring.

The elastic sleeve is downward tapered and includes a greater opening at the top thereof. A bottom portion of the elastic sleeve is mounted on the internal wall of the holding sleeve. The top of the elastic sleeve includes a flanged surface extended outward and positioned on the bearing seat.

The supporting body includes a through hole at the center thereof. The transmission shaft passes through the without contact therewith. The supporting body is mounted both on the internal wall of the bottom portion of the elastic sleeve and on the holding sleeve.

The drive shaft includes a bottom portion fixed in a coupling hole at the top of the transmission shaft such that the drive shaft is movable with the transmission shaft. The drive shaft further includes an upper portion fitting into a connection groove of the screw rod. An n-shaped disc body is extended outward from the middle portion of the drive shaft for covering the supporting body.

The compression ring is interposed between the bearing seat and the bottom of the basin and compressed against the top of the flanged surface of the elastic sleeve. Moreover, the compression ring includes a recessed portion at the internal wall thereof.

The resilient spacer is received within the recessed portion and disposed at the bottom of the basin. Moreover, the resilient spacer includes a mounting hole tightly positioned around the circumference of the drive shaft in such a way that the resilient spacer sits on the top of the n-shaped disc body. The elastic sleeve and the resilient spacer are preferably made of rubber. The material should not be restricted thereto. Any other equivalent materials are applicable.

### BRIEF DESCRIPTION OF THE DRAWINGS

The accomplishment of this and other objects of the invention will become apparent from the following descriptions and its accompanying figures of which:

FIG. 1 is a perspective view of a conventional chocolate fountain;

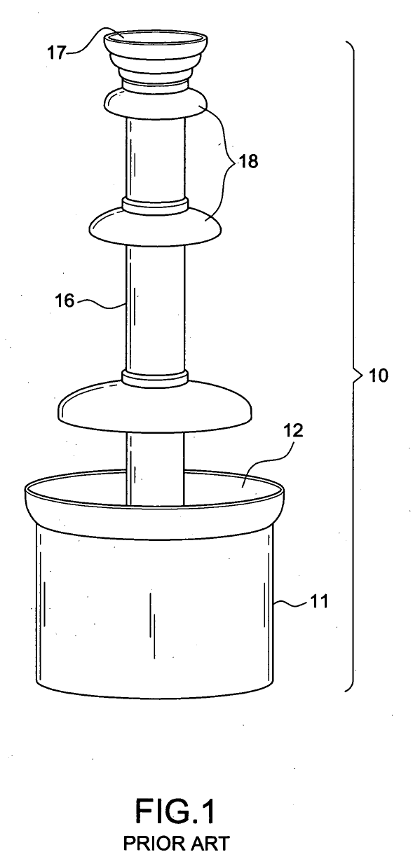

FIG. 2 is a cutaway view of the conventional chocolate fountain;

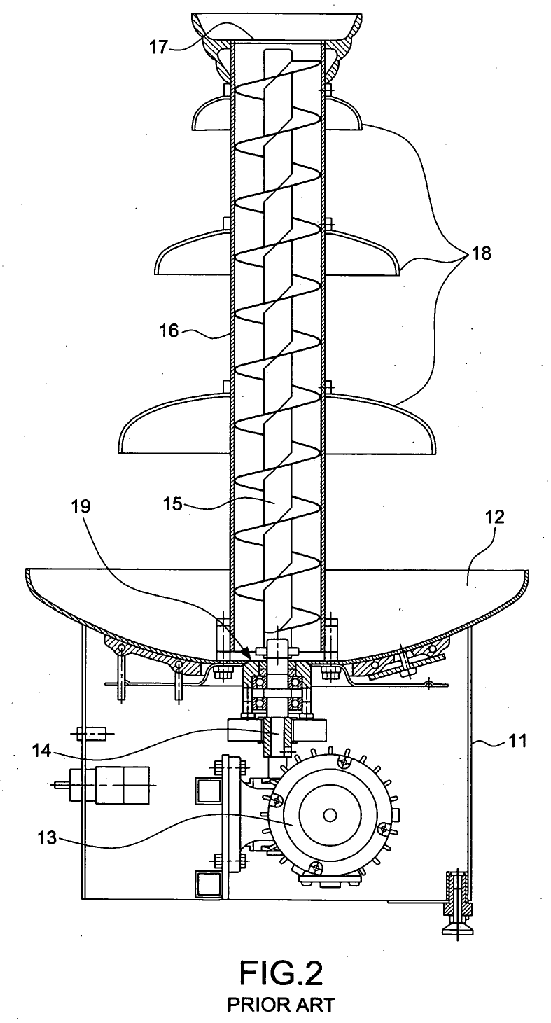

FIG. 3 is a cutaway view of another conventional chocolate fountain;

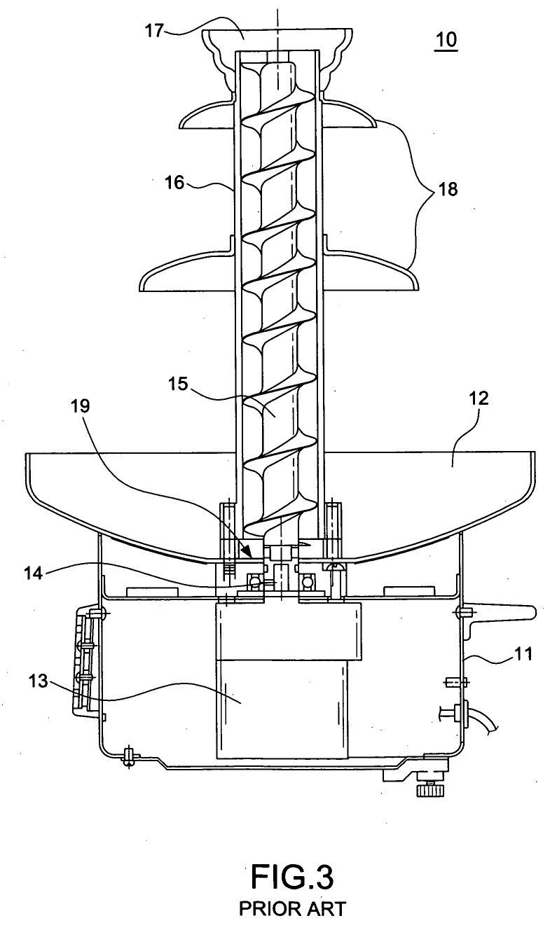

FIG. 4 is an enlarged cutaway view of the conventional shaft seal of a chocolate fountain;

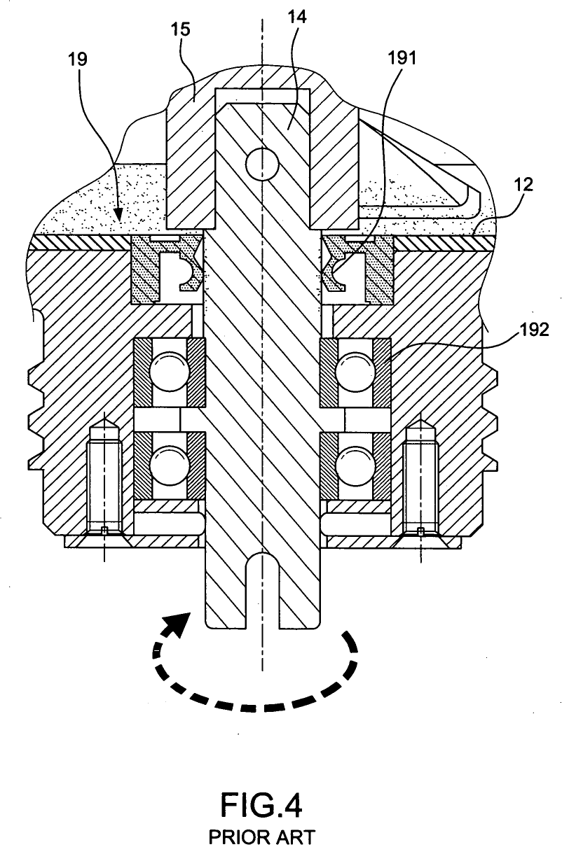

FIG. 5 is a perspective view of a preferred embodiment in accordance with the invention;

FIG. 6 is a cutaway view of the preferred embodiment in accordance with the invention;

FIG. 7 is an enlarged cutaway view of the main structure according to FIG. 6; and

FIG. 8 is an enlarged cutaway view of the main structure according to FIG. 7.

### DETAILED DESCRIPTION OF THE PREFERRED EMBODIMENT

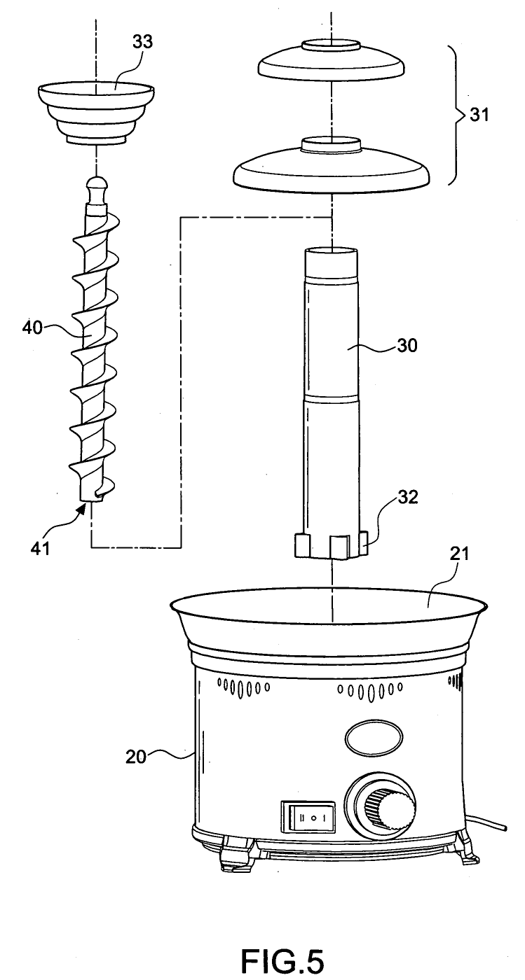

First of all, referring to FIG. 5, a preferred embodiment of a shaft seal arrangement of a chocolate fountain in accordance with the invention includes a base 20 with a basin 21 positioned thereon, and a cylinder 30 fixed at the center of the basin 21 with a fixing portion 32 at the bottom thereof. A screw rod 40 is positioned within the cylinder 30. A plurality of step-shaped tiers 31 are mounted on the periphery of the cylinder 30. A top portion 33 is positioned on the top of the cylinder 30.

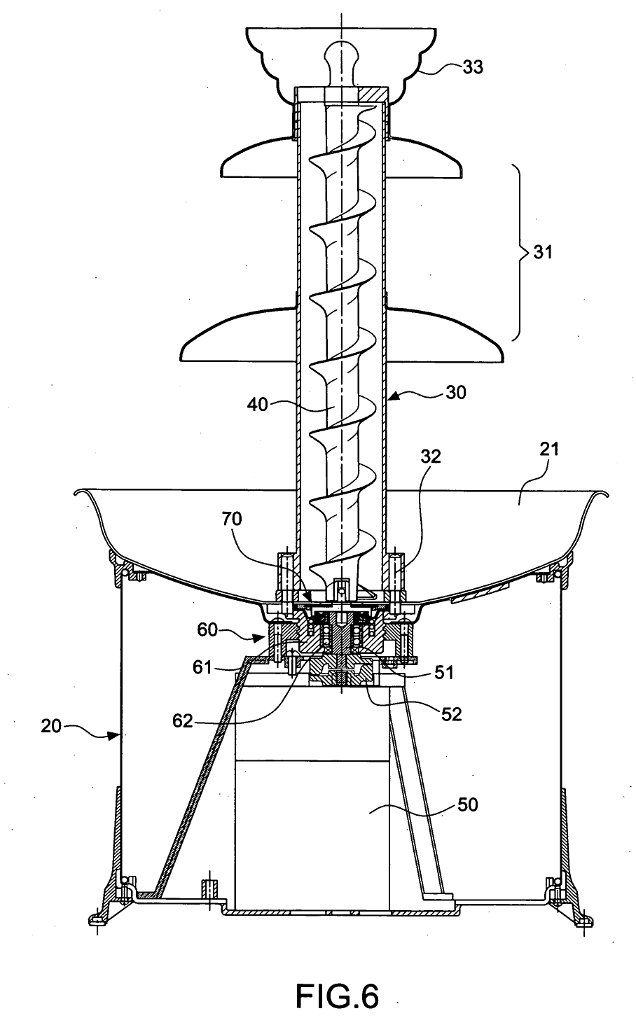

As shown in FIG. 6, a motor 50 is disposed within the base 20. A transmission shaft 51 is driven by the motor 50 via a transmission tooth disc 52. A fixing seat 60 is positioned at the top of the motor 50. A bearing seat 61 is disposed at the top of the fixing seat 60. A bearing 62 is interposed between the bearing seat 61 and the transmission shaft 51.

The above-mentioned configuration belongs to the prior art and is not the object of the invention so that no further descriptions are given hereinafter. The invention features that a shaft seal arrangement 70 adapted to the chocolate basin 21 is interposed between the transmission shaft 51 and the screw rod 40.

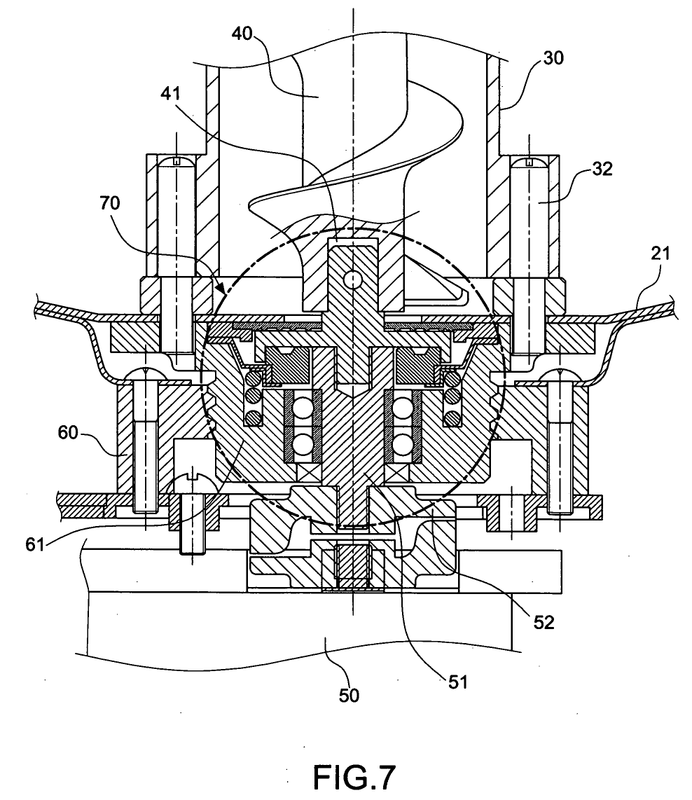

As shown in FIGS. 6 through 8, the shaft seal arrangement 70 includes a spring 71, a holding sleeve 72, an elastic sleeve 73, a supporting body 74, a drive shaft 75, a compression ring 76, and a resilient spacer 77.

The spring 71 is received within an annular groove 63 of the bearing seat 61. The annular groove 63 is formed externally and concentrically to the bearing 62.

The holding sleeve 72 is made of metallic material such as copper and U-shaped. A through hole 721 is formed at the center of the holding sleeve 72 such that the transmission shaft 51 passes through the through hole 721 without contact therewith. A flange 722 is extended from the periphery of the holding sleeve 72 and positioned on the top of the spring 71.

The elastic sleeve 73 is downward tapered and includes a greater opening at the top thereof. A bottom portion 731 of the elastic sleeve 73 is mounted on the internal wall of the holding sleeve 72. The top of the elastic sleeve 73 includes a flanged surface 732 extended outward and positioned on the bearing seat 61.

The supporting body 74 includes a through hole 741 at the center thereof. The transmission shaft 51 passes through the 741 without contact therewith. The supporting body 74 is mounted both on the internal wall of the bottom portion 731 of the elastic sleeve 73 and on the holding sleeve 72.

The drive shaft 75 includes a bottom portion 751 fixed in a coupling hole 53 at the top of the transmission shaft 51 such that the drive shaft 75 is movable with the transmission shaft 51. The drive shaft 75 further includes an upper portion 752 fitting into a connection groove 41 of the screw rod 40. An n-shaped disc body 753 is extended outward from the middle portion of the drive shaft 75 for covering the supporting body 74.

The compression ring 76 is interposed between the bearing seat 61 and the bottom of the basin 21 and compressed against the top of the flanged surface 732 of the elastic sleeve 73. Moreover, the compression ring 76 includes a recessed portion 761 at the internal wall thereof.

The resilient spacer 77 is received within the recessed portion 761 and disposed at the bottom of the basin 21. Moreover, the resilient spacer 77 includes a mounting hole 771 tightly positioned around the circumference of the drive shaft 75 in such a way that the resilient spacer 77 sits on the top of the n-shaped disc body 753. The elastic sleeve 73 and the resilient spacer 77 are preferably made of rubber. The material should not be restricted thereto. Any other equivalent materials are applicable.

The material of the supporting body 74 is selected from a group consisting of carbon, graphite, Teflon, and wearproof ceramics. The material of carbon is preferred. The top of the supporting body 74 is provided with a ring groove 742 for minimizing the contact with the n-shaped disc body 753.

Moreover, the bottom of the resilient spacer 77 is provided with a plurality of projecting ring ribs 772 arranged concentrically to one another for creating a multiple sealing effect and reducing the frictional surface.

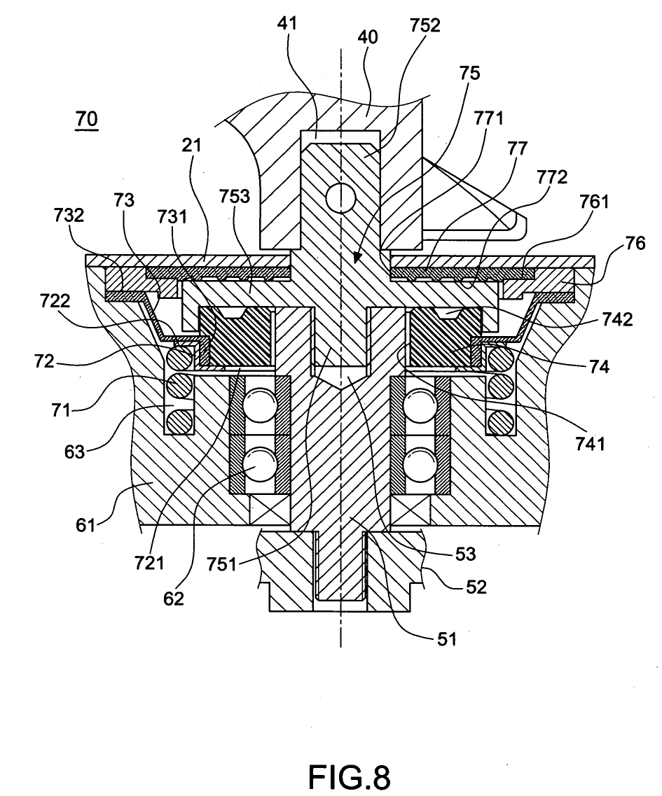

The operation of the shaft seal arrangement of a chocolate fountain in accordance with the invention is shown in FIG. 8. Based upon the above-mentioned configuration of the invention, the transmission shaft 51 and the drive shaft 75 are driven by the transmission tooth disc 52 such that the screw rod 40 within the basin 21 is rotated. At that time, the spring 71 constantly provides an upward resilience that acts on the holding sleeve 72 to force the supporting body 74 against the bottom surface of the n-shaped disc body 753 of the drive shaft 75. As a result, when the drive shaft 75 and the n-shaped disc body 753 are rotated, an upward pushing force is maintained so as to constantly force the n-shaped disc body 753 in sealed contact with the resilient spacer 77. Even when the supporting body 74 has been worn out, the spring 71 constantly provides an upward resilience that constantly pushes the supporting body 74 upward against the n-shaped disc body 753. The elastic sleeve 73 is made of elastic material and will be moved with the supporting body 74.

The shaft seal arrangement of a chocolate fountain in accordance with the invention provides an excellent shaft-sealing effect such that the melted chocolate within the basin can be prevented from downward leakage, thereby ensuring a smooth operation of the transmission element as well as a prolonged service life.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A shaft seal arrangement of a chocolate fountain, comprising:
a) a base with a basin positioned thereon;
b) a cylinder fixed at the center of the basin, a screw rod being positioned within the cylinder, a plurality of step-shaped tiers being mounted on the periphery of the cylinder;
c) a motor disposed within the base for driving a transmission shaft; and
d) a fixing seat positioned at the top of the motor, a bearing seat being disposed at the top of the fixing seat, a bearing being interposed between the bearing seat and the transmission shaft;
wherein a shaft seal arrangement is interposed between the transmission shaft and the screw rod and includes:
i) a spring received within an annular groove of the bearing seat, the annular groove being formed externally and concentrically to the bearing;
ii) a holding sleeve made of metallic material and formed in U-shape, a through hole being positioned at the center of the holding sleeve such that the transmission shaft passes through the through hole without contact therewith, a flange being extended from the periphery of the holding sleeve and positioned on the top of the spring;
iii) an elastic sleeve downward tapered and having an greater opening at the top thereof, a bottom portion of the elastic sleeve being mounted on the internal wall of the holding sleeve, the top of the elastic sleeve having a flanged surface extended outward and positioned on the bearing seat;
iv) a supporting body having a through hole at the center thereof such that the transmission shaft passes through the without contact therewith, the supporting body being mounted both on the internal wall of the bottom portion of the elastic sleeve and on the holding sleeve;
v) a drive shaft having a bottom portion fixed in a coupling hole at the top of the transmission shaft such that the drive shaft is movable with transmission shaft, the drive shaft further having an upper portion fitting into a connection groove of the screw rod, an n-shaped disc body being extended outward from the middle portion of the drive shaft for covering the supporting body;
vi) a compression ring interposed between the bearing seat and the bottom of the basin and compressed against the top of the flanged surface of the elastic sleeve, the compression ring having a recessed portion at the internal wall thereof;
vii) a resilient spacer received within the recessed portion and disposed at the bottom of the basin, the resilient spacer having a mounting hole tightly positioned around the circumference of the drive shaft in such a way that the resilient spacer sits on the top of the n-shaped disc body.

2. The shaft seal arrangement of a chocolate fountain as recited in claim 1 wherein the material of the supporting body is selected from a group consisting of carbon, graphite, Teflon, and wearproof ceramics.

3. The shaft seal arrangement of a chocolate fountain as recited in claim 2 wherein the top of the supporting body is provided with a ring groove.

4. The shaft seal arrangement of a chocolate fountain as recited in claim 1 wherein the elastic sleeve and the resilient spacer are made of rubber.

5. The shaft seal arrangement of a chocolate fountain as recited in claim 4 wherein the bottom of the resilient spacer is provided with a plurality of projecting ring ribs arranged concentrically to one another.
